(19) United States
(12) Patent Application Publication
(10) Pub. No.: US 2025/0198444 A1
(43) Pub. Date: Jun. 19, 2025

(54) APPARATUS FOR INSTALLING FASTENERS AND EXPLOSIVE LOADS FOR USE THEREWITH

(71) Applicant: JOE LIN, Missouri City, TX (US)

(72) Inventor: JOE LIN, Missouri City, TX (US)

(21) Appl. No.: 19/000,927

(22) Filed: Dec. 24, 2024

Related U.S. Application Data
(63) Continuation-in-part of application No. 17/711,175, filed on Apr. 1, 2022, now Pat. No. 12,172,276.
(63) Continuation-in-part of application No. 16/180,087, filed on Nov. 5, 2018, now Pat. No. 11,298,811.

(51) Int. Cl. F16B 19/14

(52) U.S. Cl. CPC F16B 19/14

(57) ABSTRACT

A bracket is formed from metal plate or strap stock having a length, a width and a thickness. The length is greater than the width and the width is greater than the thickness. The metal plate or strap stock forms a first section, a second section, and a third section. The third section is connected to the second section at a “J”-shaped bend for receiving a loop formed in the end of a support wire or cable. The “J”-shaped bend forms a saddle across the width of the metal plate or strap stock having an upwardly-facing convex surface for supporting the loop. In a preferred embodiment, to reduce the risk of accidental disengagement of the wire loop, the metal plate or strap stock further forms a fourth section extending from the third section above the saddle, a gap being left between the first section and the fourth section to permit passage of the loop. The fourth section functions as a hood to reduce the chance of accidental dislodgement of the loop.

### PRIOR ART

The disclosure of U.S. Pat. No. 8,397,969 issued Mar. 19, 2013 is incorporated by reference herein.

### BACKGROUND OF THE INVENTION

This invention relates broadly to explosively driven fasteners. More particularly, this invention relates to an apparatus for installing explosively driven fasteners and explosive loads and brackets for use therewith.

The fasteners with brackets as disclosed in U.S. Pat. No. 8,397,969 are of unitary construction. However, power charges, nail lengths, and bracket configuration are all individually optimized for a given application. This variability requires a large inventory of the possible power charge/nail/bracket combinations for steady work on a project, causing high inventory costs. Also, in the event of a misfire, bent nail, or excessively spalled penetration, nothing can be salvaged of the power charge/nail/bracket combination, causing waste cost to be undesirably high.

It is therefore an object of the invention to provide an improved tool for installing an explosively driven fastener that can accommodate nails of different lengths as well as an improved explosively driven fastener for use therewith that permits changeout of bracket configurations and salvage of components in the event of a malfunction.

It is a further object of this invention to provide a tool that is safer to unload or clear in the event of a malfunction or failure to fire.

It is an additional object of the invention to provide an improved bracket.

It is an additional object of the invention to provide modularity in components for casing/fastener combinations.

### SUMMARY OF THE INVENTION

A bracket is formed from metal plate or strap stock having a length, a width and a thickness. The length is greater than the width and the width is greater than the thickness. The metal plate or strap stock forms a first section, a second section, and a third section. The third section is connected to the second section at a “J”-shaped bend for receiving a loop formed in the end of a support wire or cable. The “J”-shaped bend forms a saddle across the width of the metal plate or strap stock having an upwardly-facing convex surface for supporting the loop. In a preferred embodiment, to reduce the risk of accidental disengagement of the wire loop, the metal plate or strap stock further forms a fourth section extending from the third section above the saddle, a gap being left between the first section and the fourth section to permit passage of the loop.

In another embodiment of the invention, there is provided a plastic casing carrying a metal fastener. The plastic casing has longitudinal axis and a tubular portion and a cylindrical portion positioned along the longitudinal axis. The tubular portion extends from the cylindrical portion and forms a cup. Each of the tubular portion and the cylindrical portion has an outside diameter and the outside diameters are the same. The metal fastener has a longitudinal axis, a shaft portion and a head portion positioned along the longitudinal axis. The longitudinal axis of the metal fastener coincides with the longitudinal axis of the casing. The head portion of the metal fastener is positioned in the cup formed by the tubular portion of the casing. The shaft portion of the metal fastener protrudes from the tubular portion of the casing. A sabot is positioned on the shaft portion of the metal fastener.

### BRIEF DESCRIPTION OF DRAWINGS

FIG. 1 is a longitudinal cross section of a tool in a first, relaxed configuration according to an embodiment of the invention.

FIG. 2 is a longitudinal cross section of the tool of FIG. 1 in a second, cocked configuration and carrying a nail and charge.

FIG. 3 is a longitudinal cross section of the tool of FIG. 2 in a third, triggered configuration.

FIG. 4 is a longitudinal cross section of the tool of FIG. 2 in a fourth, firing configuration.

FIG. 5 is a longitudinal cross section of the tool of FIG. 2 in a fifth, safe configuration.

FIG. 6 is a longitudinal cross section of the tool of FIG. 2 is a sixth, unload configuration.

FIG. 7 is a perspective view of an end of a tool according to an embodiment of the invention showing placement of a nail and charge.

FIG. 8 is a perspective view of the end of the tool as in FIG. 7 after placement of the nail and charge.

FIG. 9 is a perspective view of the end of the tool as in FIG. 8 showing placement of a bracket on the nail and end of the tool.

FIG. 10 is a longitudinal cross section of an end of a tool according to another embodiment of the invention illustrating placement of a nail and charge.

FIG. 11 shows fasteners according to embodiments of the invention.

FIG. 12 shows nail/charge combinations according to embodiments of the invention,

FIG. 13 shows washer/spacers according to an embodiment of the invention.

FIG. 14 shows a nail/charge/bracket combination according to an embodiment of the invention, in cross section.

FIG. 15 shows an exploded view of a tool according to an embodiment of the invention, in longitudinal cross section.

FIG. 16 is a perspective view of the end of the tool in one embodiment of the invention showing placement of a magnet in the spall shield of the tool.

FIG. 17 is a sectional view of the end of the tool as shown in FIG. 16 when carrying a nail/charge/bracket in accordance with an embodiment of the invention.

FIG. 18 is a cross sectional view of a bushing showing certain features of another embodiment of the invention.

FIG. 19 is a cross sectional view of a bracket which can be used with the bushing of FIG. 18.

FIG. 20 is a cross sectional view of a gun assembly as in earlier described embodiment with which the newly described embodiment can be used.

FIG. 21 is a cross sectional view of a bushing/bracket combination ready for insertion into the gun assembly of FIG. 20.

FIG. 22 is a cross sectional view of the bushing/bracket combination of FIG. 21 after insertion into the gun assembly.

FIG. 23 is a pictorial illustration of a bracket according to an embodiment of the invention.

FIG. 24 is a pictorial illustration of the bracket of Figure from another perspective supporting a wire loop.

FIG. 25 is a pictorial illustration of an improved version of the bracket shown in FIG. 24.

FIG. 26 is a cross sectional view of a casing carrying a metal fastener and loaded into the application device.

FIG. 27 is cross sectional view of another embodiment of a casing carrying a metal fastener and loaded into an application device.

FIG. 28 is a cross sectional view of an encased propellant charge installed on a casing.

FIG. 29 is a pictorial illustration of a sabot device for centering a metal fastener in the bore of an application device.

### DETAILED DESCRIPTION OF THE INVENTION

With reference to FIG. 11, one embodiment of the invention is in the form of a bracket, for example, one of brackets 2, 2′, 2″ for attachment to an overhead substrate to carry a suspending wire or rod. The bracket is formed from metal plate or strap stock having a bend 4, preferably a right-angle bend, connecting a first section 6 of the stock with a second section 8 of the stock. The sections are preferably generally rectangular. The first generally rectangular section of stock has a perforation, for example, at the bottom of a dimple 10 formed on one side of the stock, preferably by stamping, with a corresponding protuberance 12 protruding from the other side, for example, an extrusion, bulge or tubing, preferably a bulge. The bulge or other protuberance protrudes alongside the second generally rectangular section of stock. The bulge has a base 14 and an apex 16, a generally conical outside surface adjacent to the first generally rectangular section of stock and a through aperture 18 at the apex. The inside surface of the bulge is also generally conical. In one preferred embodiment, the bracket 2 further comprises a third section 21 of stock, preferably a rectangular section, connected to the second generally rectangular section of stock by a generally right-angle bend and extending therefrom in a plane generally parallel to the first generally rectangular section of stock in a direction away from the bulge. The third section of stock defines an aperture 22. In another embodiment, the second generally section of stock of the bracket 2″ defines a second aperture 20. In another embodiment, the second aperture 24 of the bracket 2′ is threaded to accept a threaded rod, not shown.

In a preferred embodiment, the generally conical outside surface of the bulge converges in the direction of the apex of the bulge at a half-angle in the range of about 30 to about 60 degrees. The bulge has a height that is 30 to 50% of its outside diameter at the base. The stock is steel, the first rectangular section has a length in the range of about 1 to about 4 cm, a width in the range of about 1 to about 4 cm, a thickness in the range of about 0.1 to about 0.3 cm, and the bulge has an outside diameter at the base in the range of about 0.5 to about 1 cm.

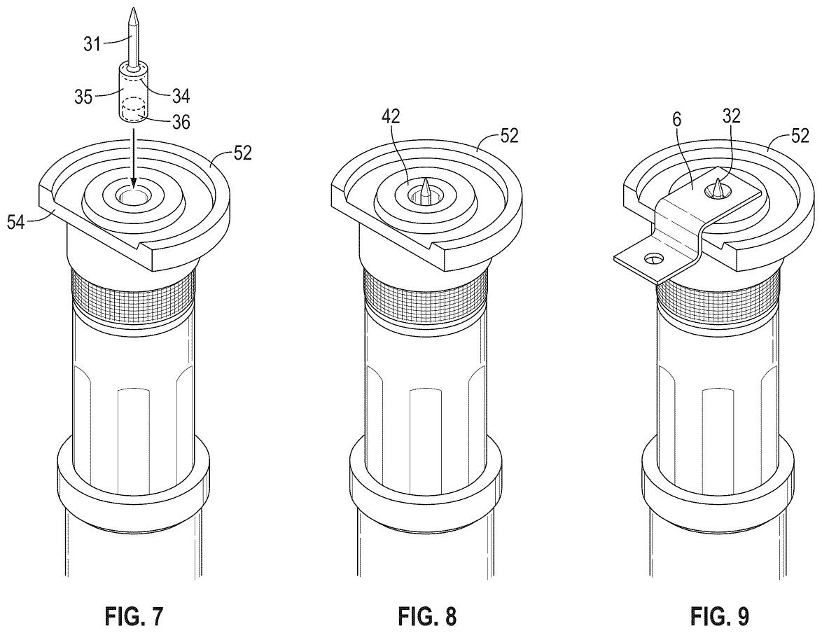

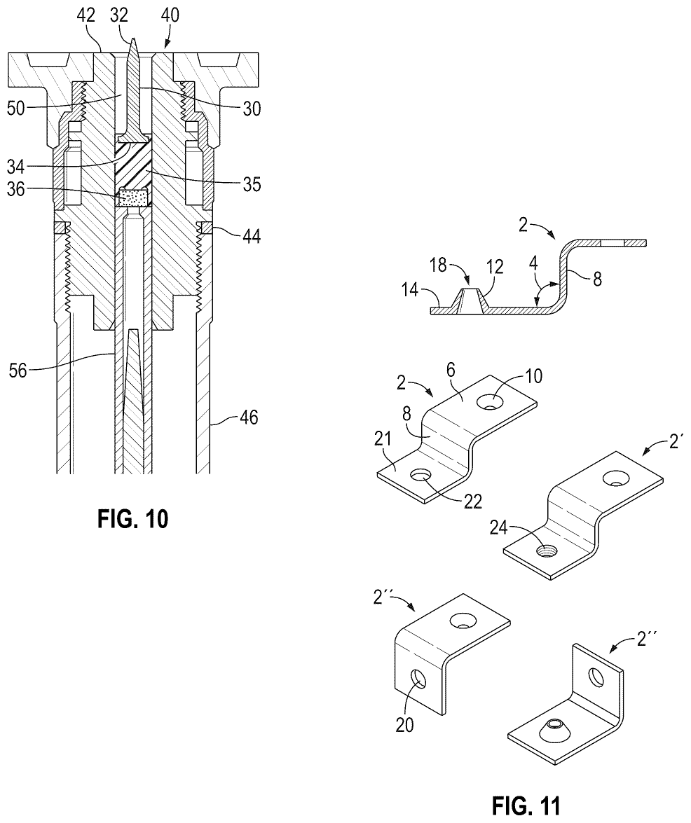

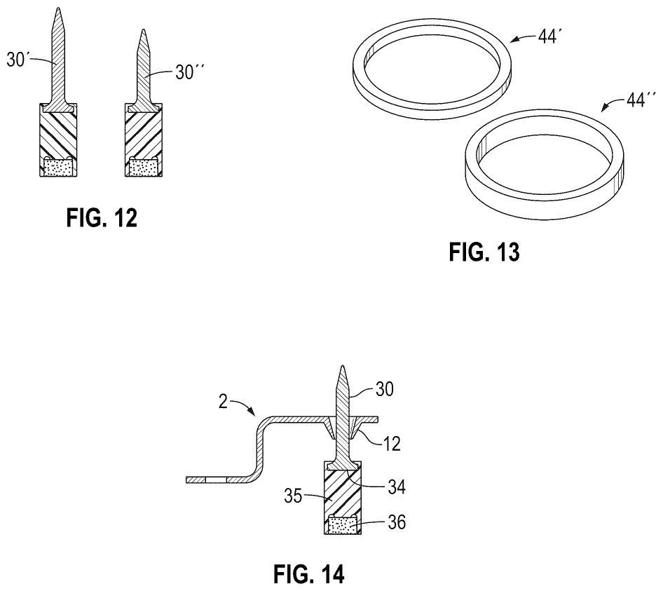

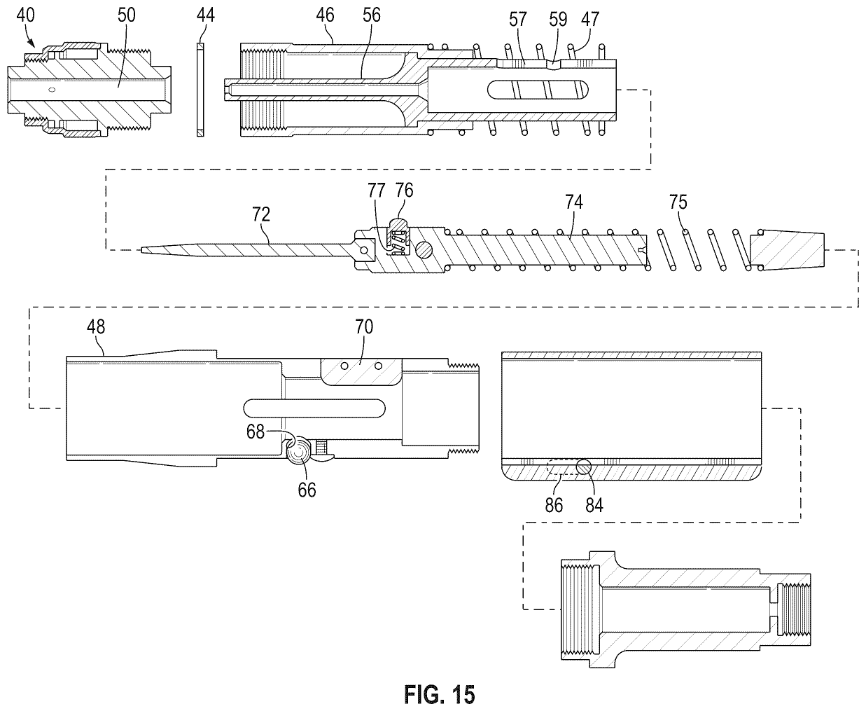

The brackets of the invention are used in conjunction with a nail 30. See FIGS. 10 and 14. Different length nails 30′, 30″ for example can be used for different application. See FIG. 12. The nail has a cylindrical shaft 31 (See FIG. 7), a longitudinal axis, a pointed distal end 32 and a proximal nail head 34. The cylindrical shaft is positioned loosely and slidably in the through-aperture of the apex (see FIG. 14) with the pointed distal end protruding in the range of about 0.1 to about 0.5 cm above a surface 7 of the first generally rectangular surface opposite to the protuberance. See FIG. 9.

With reference to FIG. 7 for example, the nail is preferably used in combination with a plastic cap 35 having a distal end, a proximal end, and a longitudinal axis. The distal end surrounds the nail head. The proximal end contains a nitrocellulose load 36. Different strength loads can be provided if needed. The plastic cap is generally cylindrical in shape and has its longitudinal axis positioned coaxially with the longitudinal axis of the nail shaft. The plastic cap preferably has an outside diameter slightly smaller than the outside diameter of the bulge or other protuberance at its base 14. The cap, nitrocellulose load, and nail are manufactured as a unit.

The nail generally has a length between the distal end and the proximal end that is in the range of 2 to 5 cm and the plastic cap and/or nitrocellulose load is preferably color-coded dependent on the length of the nail.

Conventional fasteners are comprised of nails and brackets hooks or clips that are mostly assembled using a press-tight fitting or through additional metal fittings that need to be combined before use. The disadvantage of this design is that when the assembled, complete fastener fails to fix to the substrate or the nail fails to shoot, the entire fastener assembly is scrapped and cannot be reused, resulting in excess waste. This invention can reuse the same bracket and, providing that the nail/cap/load piece is replaced, reduces waste.

As compared to using a tight-fitting bracket, the bracket only loosely covers the nail piece in the invention, and the tool is adjusted with a color-coded washer 44, 44′, 44″ for example so that the point of the nail piece protrudes above the bracket no more than 5 millimeters. A bowl-shaped structure is provided on the underside of the bracket which enters completely into the tool beneath the bracket beneath the nail tip. This bowl structure enters completely into the tube of the tool cover, preventing nails from sliding when applying the bracket to the substrate. The feature assures that the nail is driven in straight.

To determine the shortest usable nail length, load the nail into the nosepiece of the tool until the head of the nail starts to touch the firing pin guide inside of the tool, then loosely encase the nail with the hook/clip bracket piece. When the point of the nail protrudes no more than 5 millimeters the shortest length of nail that can be used has been determined. The solution to the issue of coupling different lengths of nails is in utilizing different thicknesses of spacers to adjust the nail protrusion. The different lengths of spacers allow different lengths of nails to be loaded into the tube and ensure that after equipping the bracket the nail does not protrude more than within a 5-millimeter range outside the barrel of the nosepiece.

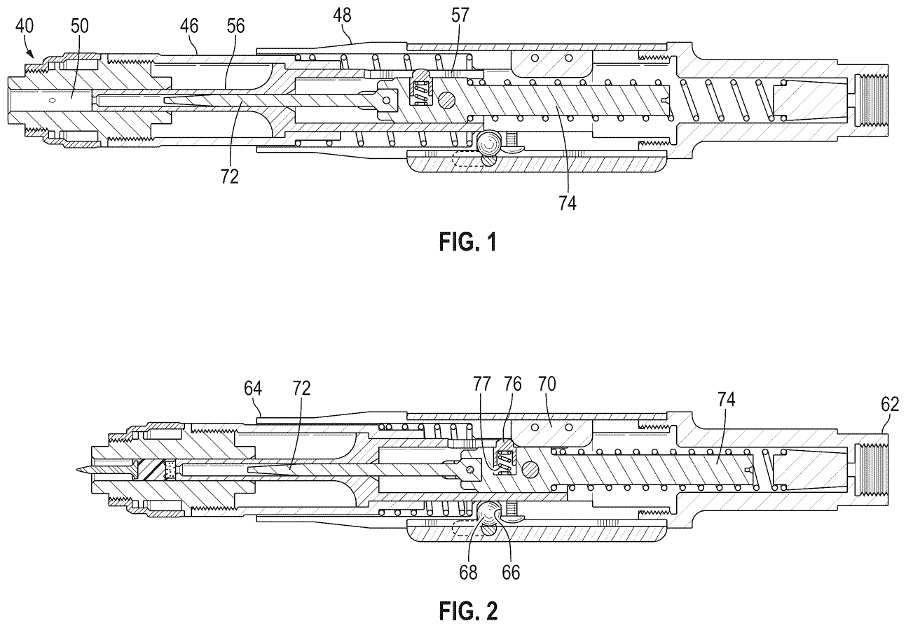

The combination is preferably used in conjunction with a muzzle assembly 40, (See FIG. 10) a color coded washer 44, 44′, 44″, an inner sleeve 46, and a receiver 48 (see FIG. 1). The inner sleeve has a distal annular endface and a proximal end. The muzzle assembly defines a generally cylindrical throughbore 50 and having a distal end and a proximal end and the distal end defines an annular endface 42. The distal end of the muzzle assembly closely receives the proximal end of the plastic cap in the throughbore. The proximal end of the muzzle assembly is threaded to the inner sleeve. The color-coded washer is retained between annular endfaces on the muzzle assembly and the inner sleeve. The inner sleeve is slidably carried by the receiver.

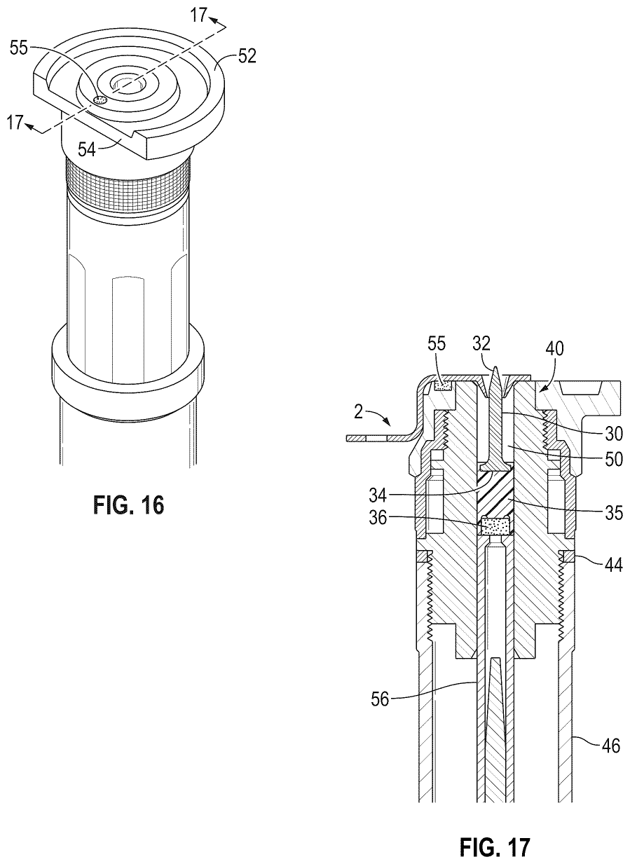

The distal annular endface of the muzzle assembly contacts the first section of stock. See FIG. 9. A rubbery spall shield 52 is preferably carried on the muzzle assembly and has a segment cutaway 54 to accommodate the bracket. The cutaway has the added benefit of preventing the bracket from spinning around during manipulation of the tool. The spall shield has a distal annular endface that surrounds and is approximately co-planar with the distal annular endface of the muzzle assembly. A magnet 55 is preferably mounted in a recess, for example, a borehole, in the distal annular endface of the spall shield. The magnet is preferably located between the distal annular endface of the muzzle assembly and the cutaway. See FIG. 16. The magnet can be cylindrically shaped and can be secured by adhesive. The magnet preferably has a flat distal face that is approximately co-planar with the distal annular endface of the spall shield. The magnet helps locate the bracket after it has been placed. See FIG. 17. The tool further comprises a firing pin guide 56 having a distal end and a proximal end slidably mounted in the generally cylindrical throughbore of the muzzle assembly. The distal end of the firing pin guide supports the proximal end of the plastic cap so that the pointed distal end of the nail protrudes in the range of about 0.1 to about 0.5 cm above a surface of the first generally rectangular surface of the bracket opposite the protruding bulge. The color coded washer has a thickness as measured longitudinally which is related to the color code of the plastic cap and/or nitrocellulose load to space the distal end of the muzzle assembly from the distal end of the inner sleeve adequately to cause the distal end of the nail to protrude above the surface of the bracket in the range of 0.1 to 0.5 cm when the colors match.

The generally cylindrical throughbore of the muzzle assembly preferably has an inside diameter that is slightly larger than an outside diameter of the plastic cap. The throughbore preferably has a chamfer where it opens onto the distal endface of the muzzle assembly to provide a nest for the bulge. By accommodating the bulge, a proximal surface of the bracket can lie flat against the distal end surface of the muzzle assembly so that the bracket is stably positioned on the end of the tool.

In a preferred embodiment, the firing pin guide has an annular outwardly extending proximally facing flange 58 between the distal end and the proximal end and the inner sleeve has an annular inwardly extending distally facing flange 60 between the distal end and the proximal end for abutting the annular outwardly extending proximally facing flange of the firing pin guide. See FIG. 6. This causes the firing pin guide and the inner sleeve to move proximally together when the firing pin guide is urged proximally.

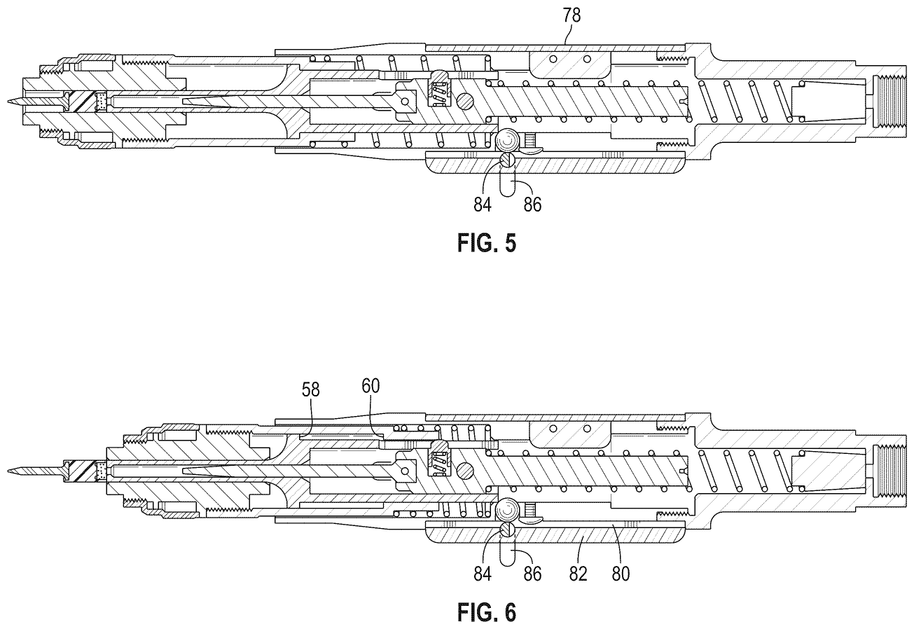

The receiver has a first end 62 a second end 64 and a sidewall extending between the first end and the second end. The receiver defines a transverse borehole 66 extending though the sidewall. A safety blocking element 68 is mounted for radial movement in the borehole to selectively block the firing pin guide from proximal movement. Compare FIGS. 1 and 5. The receiver further carries a trigger shoe 70 extending radially inwardly from the sidewall of the receiver at a location between the safety blocking element and the proximal end of the receiver.

A firing pin 72 is mounted in the firing pin guide. A firing pin plunger 74 is mounted to the firing pin and extends longitudinally proximally therefrom. A trigger plunger 76 is mounted in a transverse passage in firing pin plunger and is biased radially outwardly to move proximally with the firing pin guide until depressed by the trigger shoe. The safety blocking element when engaged prevents the firing pin guide from moving sufficiently proximally for the trigger plunger to be depressed by the shoe.

In a preferred embodiment, an outer sleeve 78 is mounted on the receiver. The outer sleeve has a longitudinal axis, a longitudinally extending inner slot 80, and an outwardly protruding portion 82 defining a radially outwardly extending ridge over the slot. See FIG. 6. The radially extending ridge defining a transverse borehole and a cam 84 is mounted in the borehole and extends across the slot. An arm 86 is mounted on one end of the cam to permit about a 90-degree rotation of the cam. The outer sleeve is mounted on the receiver so that the cam depresses the safety blocking element and prevents the firing pin guide from moving sufficiently proximally for the trigger plunger to be depressed when actuated.

The distal end of the firing pin guide is near the distal end of the barrel when the firing pin guide contacts the safety blocking element to permit ejection of the plastic cap from the generally cylindrical throughbore of the muzzle assembly by moving the inner sleeve proximally. See FIG. 6. The blocking element preferably comprises a ball bearing, as illustrated.

Another embodiment of the invention is provided in the form of a tool 100 for installing an explosively driven fastener. The fastener includes a nail, an explosive load attached to the nail, and a separate bracket. The tool comprises a receiver 48, a firing pin plunger 74, a firing spring 75, a firing pin 72, and a muzzle assembly 40. The firing pin plunger is located within the receiver. The firing pin plunger has a proximal end and a distal end. The firing spring is arranged to bias the firing pin plunger out of the receiver. The firing pin has a proximal end and a distal end. The distal end is pointed. The firing pin is separate from the firing pin plunger. The proximal end of the firing pin is removably coupled to the distal end of the firing pin plunger. The muzzle assembly has a proximal end and a distal end. The proximal end is arranged to receive the firing pin and the distal end is arranged to receive the nail and explosive load, and a portion of the bracket, such that when the fastener is placed on the distal end of the muzzle assembly and the firing pin plunger is biased out of the receiver by the firing spring, the firing pin strikes the explosive load causing the explosive load to explode and drive the nail 30 out of the muzzle assembly.

Preferably, the tool further comprises an inner sleeve 46 coaxially mounted within the receiver. The inner sleeve has a proximal end and a distal end. An inner sleeve spring 47 biases the inner sleeve away from the receiver. An annular spacer 44 is positioned between the distal end of the annular sleeve and the proximal end of the muzzle assembly. The fastener includes the nail 32, an explosive load 36 attached to the nail, and a separate bracket 2 loosely penetrated by the nail. The distal end of the muzzle assembly is chamfered to nest a portion of the bracket which is bulged out frustoconically. If desired, a second annular spacer having a different thickness longitudinally than the annular spacer can be provided to change a distance that the distal end of the nail protrudes from the distal end of the muzzle assembly or provide for the use of different length nails. Generally speaking, the spacer has an adequate thickness to cause the distal end of the nail to protrude in the range of 0.1 to 0.5 cm above the distal end of the muzzle assembly. Preferably, a distal end of the muzzle assembly supports most of a flat portion of the bracket around the bulge. More preferably, the distal end of the muzzle assembly supports most all of a flat portion of the bracket around the bulge. See FIG. 9.

This invention also adds a series of spacers with different thicknesses based on the existing tool, which is used to adjust the tool to allow the use of different lengths of pins. The invention allows the user to be able to match all different kinds of hooks & clip devices depending on application, greatly increasing its versatility, thus reducing product SKU's and lowering inventory cost.

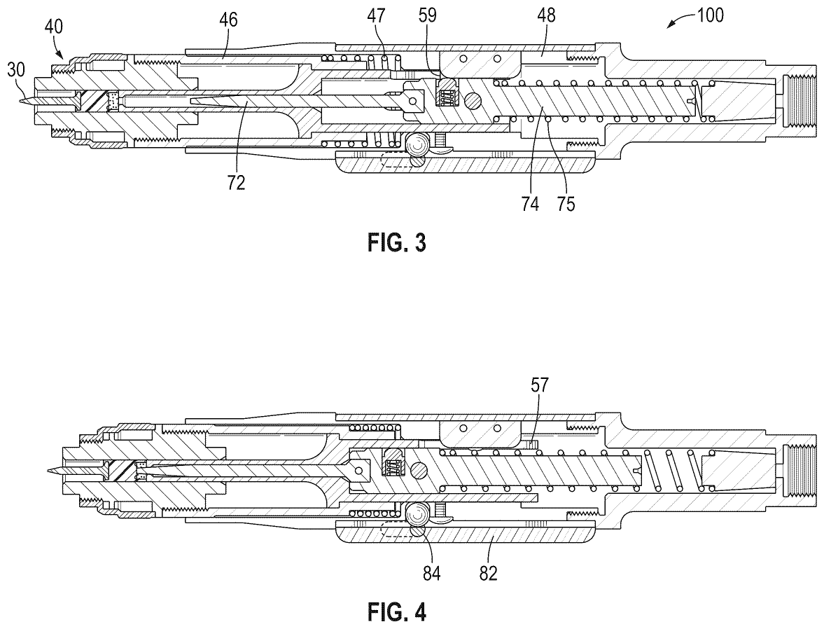

In a preferred embodiment, the tool comprises a firing pin guide 56 extending into the receiver, the inner sleeve and the muzzle assembly. The firing pin guide has an outer flange 58 and the inner sleeve has an inner flange 60 engageable by the outer flange. A trigger plunger 76 and a trigger spring 77 mounted transversely in the firing pin plunger, the trigger being biased radially outward from within the firing pin plunger. The firing pin guide has a slot 57 extending from the proximal end and a widened area 59 in the slot to receive the trigger plunger. The receiver has an internal trigger shoe 70 receivable by the keyway to depress the trigger plunger by sliding over it. When the tool is in a first resting position, (FIG. 1) the trigger plunger rests in the widened area of the slot thereby limiting distal movement of the firing pin. When the tool is in a second firing position (FIG. 3), the trigger shoe depresses the trigger plunger out of engagement with the firing pin guide and allows distal movement of the firing pin under the action of the firing spring.

In a preferred embodiment, the receiver has a first end a second end and a sidewall extending between the first end and the second end. The receiver defines a transverse borehole 66 extending though the sidewall. The tool further comprises a safety blocking element 68 mounted for radial movement in the borehole to selectively block the firing pin guide from proximal movement. The safety blocking element when engaged prevents the firing pin guide from moving sufficiently proximally for the trigger plunger to be depressed by the shoe.

More preferably, an outer sleeve 78 is mounted on the receiver. The outer sleeve has a longitudinal axis, a longitudinally extending inner slot, and an outwardly protruding portion 82 defining a radially outwardly protruding, longitudinally extending ridge over the slot. The ridge defines a transverse borehole. A cam 84 is mounted in the borehole and extends across the slot. An arm 86 on one end of the cam permits about a 90-degree rotation of the cam. The outer sleeve is positioned on the receiver so that the cam depresses the safety blocking element and prevents the firing pin guide from moving sufficiently proximally for the trigger plunger to be depressed.

Another embodiment of the invention is provided in the form of a tool 100 having a safety device for installing an explosively driven fastener, the fastener including a nail and an explosive load attached to the nail. The tool comprises a receiver 48, a firing pin plunger 74, a firing spring 75, a firing pin 72, a muzzle assembly 40, a trigger plunger 76 and spring 77, a firing pin guide, and a safety blocking element. The firing pin plunger is located within the receiver. The firing pin plunger has a proximal end and a distal end. The firing spring is arranged to bias the firing pin plunger out of the receiver. The firing pin has a proximal end and a distal end. The distal end is pointed. The firing pin is separate from the firing pin plunger. The proximal end of the firing pin is removably coupled to the distal end of the firing pin plunger. The assembly has a proximal end and a distal end. The proximal end is arranged to receive the firing pin and the distal end is arranged to receive the nail and explosive load, and a portion of the bracket, such that when the fastener is placed on the distal end of the muzzle assembly and the firing pin plunger is biased out of the receiver by the firing spring, the firing pin strikes the explosive load causing the explosive load to explode and drive the nail 30 out of the muzzle assembly. The firing pin guide extends into the receiver, the inner sleeve 46 and the muzzle assembly. The firing pin guide has an outer flange 58 and the inner sleeve has an inner flange 60 engageable by the outer flange. The trigger plunger 76 and trigger spring 77 are mounted transversely in the firing pin plunger, the trigger being biased radially outward from within the firing pin plunger. The firing pin guide has a slot 57 extending from the proximal end and a widened area 59 in the slot to receive the trigger plunger, and the receiver has an internal trigger shoe 70 receivable by the keyway to depress the trigger plunger by sliding over it. When the tool is in a first resting position, the trigger plunger rests in the widened area of the slot thereby limiting distal movement of the firing pin, and when the tool is in a second firing position, the trigger shoe depresses the trigger plunger out of engagement with the firing pin guide allows distal movement of the firing pin under the action of the firing spring.

The receiver has a first end a second end and a sidewall extending between the first end and the second end. The receiver defines a transverse borehole 66 extending though the sidewall. The safety blocking element 68 is mounted for radial movement in the borehole to selectively block the firing pin guide from proximal movement. When engaged, the safety blocking element prevents the firing pin guide from moving sufficiently proximally in the receiver for the trigger plunger to be depressed by the shoe.

More preferably, an outer sleeve 78 mounted on the receiver. The outer sleeve has a longitudinal axis, a longitudinally extending inner slot, and an outwardly protruding portion defining a radially outwardly protruding, longitudinally extending ridge over the slot. The ridge defines a transverse borehole. A cam 84 is mounted in the borehole and extends across the slot. An arm 86 on one end of the cam permit about a 90-degree rotation of the cam. The outer sleeve is mounted on the receiver so that the cam blocks radially outward movement of the safety blocking element and prevents the firing pin guide from moving sufficiently proximally for the trigger plunger to be depressed when it is actuated. Preferably, the safety blocking element comprises a ball bearing.

One embodiment of the invention is to provide a safety device that prevents the firing function of the tool when the safety is properly engaged. Besides conforming to the traditional requirements of fastening tools that require the user apply a specific amount of compression force to actuate the tool upon contact with the substrate, this device has an added safety catch to disable the device from firing when not in use. Actuating the safety while servicing the tool or dislodging jammed fasteners helps avoid accidents and ensure increased safety.

A round steel bearing is installed in the receiver. The bearing is longitudinally spaced in front of the trigger. When used to apply fasteners, the bearing is able to move up and down radially without influencing actuation by trigger. The safety mechanism, when engaged, puts a pressure release on the head of the steel bearing which stops the bearing from moving up and down radially and prevents the radial movement of the trigger plunger, thus inhibiting the mechanism's ability to fire.

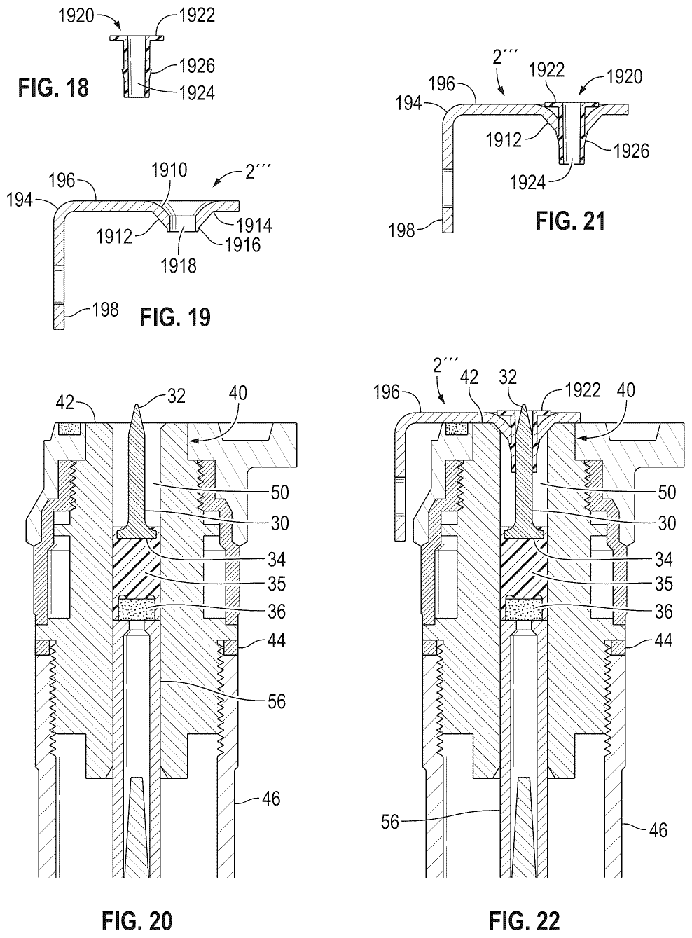

Another embodiment of the invention, with reference to FIGS. 18-22, comprises a bracket 2′″ for attachment to an overhead substrate to carry a suspending wire or rod. The bracket is formed from metal plate or strap stock having a bend 194, preferably a right-angle bend, connecting a first section 196 of the stock with a second section 198 of the stock. The sections are preferably generally rectangular. The first generally rectangular section of stock has a perforation 197, for example, at the bottom of a dimple 1910 formed on one side of the stock, preferably by stamping, with a corresponding protuberance 1912 protruding from the other side, for example, an extrusion, bulge or tubing, preferably a bulge. The bulge or other protuberance protrudes alongside the second generally rectangular section of stock. The bulge has a base 1914 and an apex 1916, a generally conical outside surface adjacent to the first generally rectangular section of stock and a through aperture 1918 at the apex. The inside surface of the bulge is also generally conical, in the illustrated embodiment, frustoconical where it opens onto the upper surface of the bracket, and generally cylindrical at the aperture 1918. The aperture is of larger diameter than the aperture of earlier embodiments to accommodate a plastic bushing 1920 extending through the through-aperture. See FIG. 21. The bushing is preferably constructed of a thermoplastic material, for example, Nylon®. The bushing has a first end and a second end. An annular flange 1922 extends radially outwardly at its first end. A through-passage 1924 extends from the first end to the second end. The annular flange at the first end of the plastic aperture is received by the dimple on the upper surface of the bracket. The plastic bushing has a generally cylindrical or slightly tapered outer surface that is closely received by the through-aperture opening at the apex of the protuberance. In the illustrated embodiment, the bushing has at least one fin or barb 1926 protruding from its generally cylindrical outer surface contacting the apex of the protuberance to retain the annular flange in the dimple.

The bracket/bushing combination is used in combination with a nail 30, cap 35 and load 36, and gun muzzle assembly 40. The nail has a cylindrical shaft, a longitudinal axis, a pointed distal end 32 and a proximal nail head 34. The cylindrical shaft is positioned snugly in the through-passage of the bushing, and this is different from the embodiments described earlier herein. The pointed distal end of the nail protrudes in the range of about 0.1 to about 0.5 cm above a surface of the first section of stock opposite to the protuberance. The plastic cap has a distal end, a proximal end, and a longitudinal axis. The distal end surrounds the nail head and the proximal end contains the nitrocellulose load. The plastic cap is generally cylindrical in shape and has a longitudinal axis positioned coaxially with the longitudinal axis of the nail shaft. The plastic cap has an outside diameter slightly smaller than the outside diameter of the protuberance at the base. The muzzle assembly defines a generally cylindrical throughbore 50 and has a distal end and a proximal end. The throughbore closely receives the plastic cap. The throughbore having a chamfer where it opens onto the distal endface of the muzzle assembly to provide a nest for the bulge and to permit a proximal surface of the bracket to lie flat against the distal end surface 42 of the muzzle assembly. Because the bushing fits snugly onto the nail, the magnet on the distal face of the muzzle assembly can be eliminated if desired.

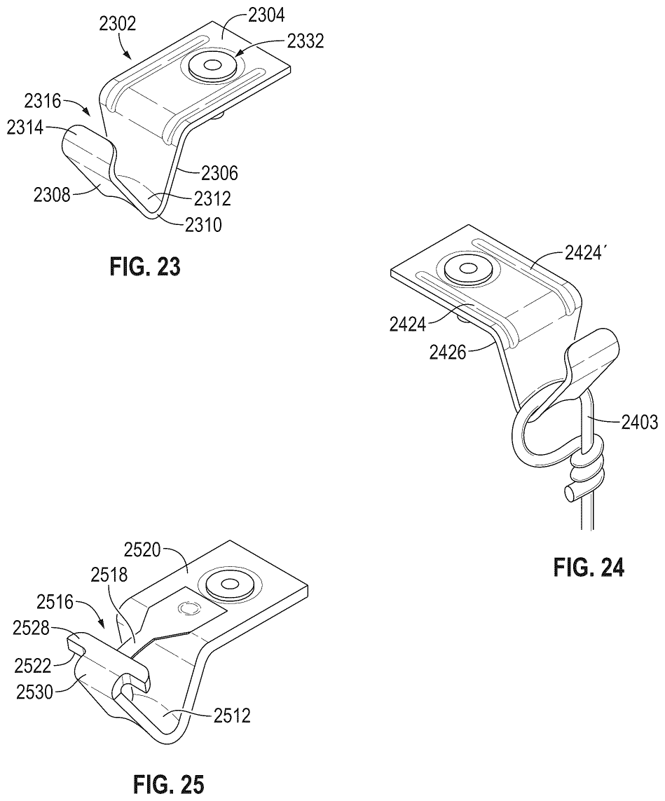

In another embodiment of the invention, there is shown a bracket 2302 (FIG. 23) for attachment to an overhead substrate to carry a suspending wire or cable forming a loop. The bracket shown in FIG. 24 is the same as the bracket shown in FIG. 23 except the wire loop 2403 has been shown. The bracket is formed from metal plate or strap stock having a length, a width and a thickness. The length is greater than the width and the width is greater than the thickness. The metal plate or strap stock forms a first section 2304, a second section 2306, and a third section 2308. The third section is connected to the second section at a “J”-shaped bend 2310 for receiving the loop. The “J”-shaped bend forms a saddle 2312 across the width of the metal plate or strap stock having an upwardly-facing convex surface for supporting the loop. In a preferred embodiment, to reduce the risk of accidental disengagement of the wire loop, the metal plate or strap stock further forms a fourth section 2314 extending from the third section above the saddle, a gap 2316 being left between the first section and the fourth section to permit passage of the loop. The fourth section functions as a hood to reduce the chance of accidental dislodgement of the wire loop. If desired, the dimensions of the bracket can also be adjusted during fabrication to position the fourth section sufficiently close to the overhead substrate location to prevent passage of the loop between the overhead substrate and the fourth section of the bracket when the bracket is attached to the overhead substrate.

In a preferred embodiment, a gate element 2518 extends across the gap 2516 above the saddle 2512. The gate element can constitute a flexible or malleable portion for the retention of single or multiple preinstalled pretied wire(s) or braided cable(s) while allowing them to be removed and installed on a replacement clip should fastening of the initial clip onto the work surface be unsuccessful. The clip may incorporate design features such as the dimple or press-fit bushing described earlier herein. The gate element swings downwardly toward the saddle. More preferably, gate element comprises a spring plate extending from an upper surface 2520 of the first section to a lower surface 2522 of the fourth section. The spring plate can be attached by riveting or welding, for example, or by press-fit, or by a stamped steel element driven through a rectangular cutout in the spring plate. The spring plate could also be retained by folding it around the clip, or by any other means. For economy, to accommodate the use of lightweight material, the first section forms at least two stamped ridges 2424, 2424′ protruding downwardly and extending in the length direction of the strap to increase stiffness of the first section under load. See FIGS. 23 and 24 and note the greater thickness of the material in FIG. 25. Tabs on the bottom or side edges could also be employed. When used, the at least two stamped ridges preferably extend partway around a bend 2426 connecting the first section with the second section. In a preferred embodiment, the width of the third section of metal plate or strap stock is less than the width of the first section, and the width of the fourth section of metal plate or strap stock is greater than the width of the third section of metal plate or strap stock, the fourth section of metal plate or strap stock forming a “T” head 2528 on the bracket. The third section of metal plate or strap stock forms a neck 2530 where it connects to the fourth section of metal plate or strap stock. Also preferably, the upwardly-facing convex surface has a radius of curvature in the range of 0.5 to 5 times the width of the first section of metal plate or strap stock. More preferably, the convex surface is multi-radiused, to conform to the natural curve of the pretied wire and braided cable loops, allowing them to sit flush on the hook and avoid the additional stress and bending points that hanging a wire or cable loop on a flat clip would introduce, As described elsewhere herein, the first section of stock has an upper surface and a lower surface and defines a through-aperture and a protuberance on the lower surface that protrudes alongside the second section of stock. The protuberance has a base and an apex, with the through-aperture opening at the apex, and the protuberance forms a bulge having a generally conical outside surface, the upper surface of the first section defining a dimple forming the inside of the bulge. A bushing or grommet 2332 is positioned in the aperture to receive a nail or pin having a cylindrical shaft, a longitudinal axis, and a pointed distal end.

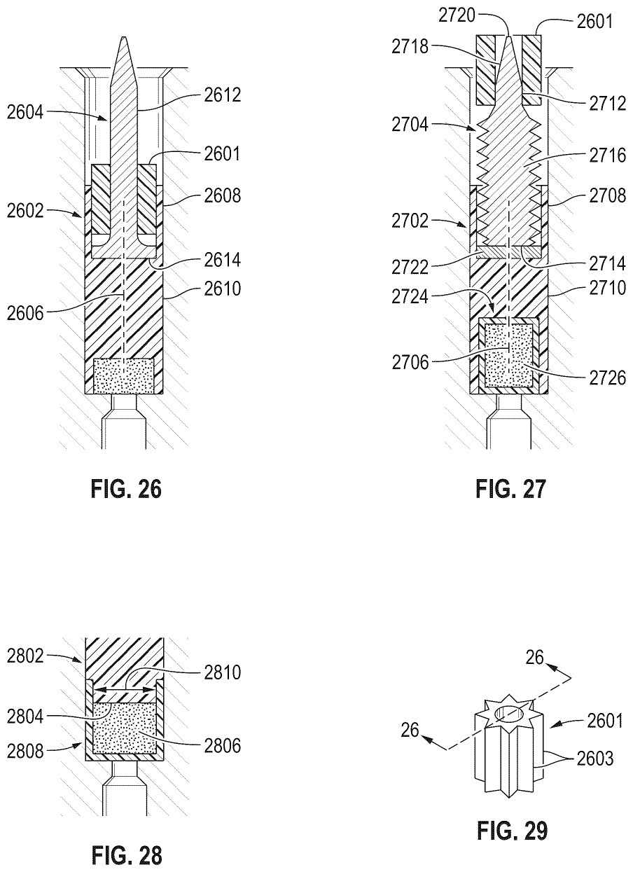

In another embodiment of the invention, there is provided a plastic casing 2602, 2702 carrying a metal fastener 2604, 2704. See FIGS. 26 and 27. The plastic casing can be formed from a thermoplastic, such as nylon. The plastic casing has a longitudinal axis 2606, 2706, a tubular portion 2608, 2708 and a cylindrical portion 2610, 2710 positioned along the longitudinal axis. The tubular portion extends from the cylindrical portion and forms a cup. Each of the tubular portion and the cylindrical portion has an outside diameter and the outside diameters are the same. The metal fastener has a longitudinal axis, (2606, 2706 since the elements are coaxial), a shaft portion 2612, 2712 and a head portion 2614, 2714 positioned along the longitudinal axis. The longitudinal axis of the metal fastener coincides with the longitudinal axis of the casing. The head portion of the metal fastener is positioned in the cup formed by the tubular portion of the casing. The shaft portion of the metal fastener protrudes from the tubular portion of the casing. A sabot 2601 is positioned on the shaft portion of the metal fastener. The sabot has a tubular body. Preferably, the tubular body of the sabot is formed from an elastomeric substance and closely fits the shaft portion of the fastener. More preferably, the sabot has a plurality of ridges 2603 extending longitudinally and radially outwardly from the tubular body of the sabot. See FIG. 29.

In one embodiment of the invention, the shaft portion of the metal fastener has a first end portion 2716 that is threaded and a second end portion 2718 that terminates in a tip 2720. The sabot is positioned on the second end portion. Where the head of the fastener is too small for adequate support against cylindrical portion of the casing, a metal disk 2722 is positioned between the head of the metal fastener and the cylindrical portion of the casing.

In the embodiment shown in FIG. 28, the cylindrical portion 2802 of the casing has a first end 2804 and a second end (not shown), and a cylindrically shaped explosive load 2806 encased in a plastic cup 2808 is positioned in covering relationship with the first end of the cylindrical portion of the plastic casing. The arrangement makes it simple to change out explosive loads. The casing and/or the explosive charge can be color coded to facilitate this. Preferably, the cylindrical portion of the plastic casing has a first outside diameter 2810 extending from the first end of the cylindrical portion of the plastic casing and a second outside diameter extending from the second end of the cylindrical portion. The second diameter is larger than the first, and the plastic cup is positioned snugly over the first outside diameter of the cylindrical portion of the plastic casing. The plastic cup has an outside diameter the same as the second outside diameter of the cylindrical portion of the casing. In the embodiment of the invention shown in FIG. 27, the cylindrical portion of the casing has a first end and a second end and the first end defines a cup 2724 that snugly receives a cylindrically shaped explosive charge. In the embodiment shown, the cylindrically shaped explosive charge 2726 is encased in plastic.

In preferred embodiments, the cylindrical plastic casing contains a nitrocellulose load pressed into a receiving opening on one end of the plastic cap, with the load (pill) left exposed for color identification of the power level of the load. Alternatively, the nitrocellulose load can be enclosed by a color-coded outer cap which snaps over the pill and plastic casing, the color of which will indicate the power level of the load. Also alternatively, the nitrocellulose load can be enclosed by a color-coded inner cap which slides into a hollow cylindrical cavity on the end of the plastic casing, the color of which will indicate the power level of the load.

Additional benefits of an outer cap that snaps over the pill and plastic casing include that the outer cap will protect the pill from physical damage during shipping and handling, and the outer cap will also prevent the pill from absorbing humidity from the air and protect it from water damage. Outer caps of varying lengths can be used to fit different pill lengths corresponding with various power loads.

On the other end of the plastic cap, there is a hollow cylindrical opening. A circular steel insert can be placed in this opening to support the firing of pins with small head surfaces, such as threaded studs. The circular steel insert is not needed to allow the firing of typical pins with larger head surface areas. The steel insert also prevents or at least mitigates the threads from becoming fouled with plastic when the threaded stud is fired.

The body of the cylindrical plastic casing should have adequate thickness between the end of the casing containing the nitrocellulose load and the hollow end carrying the pin, with or without a steel insert to drive the fastener successfully without splitting open whenever the nitrocellulose is fired. Generally speaking, about 6 to 12 mm material thickness will be used between the end of the casing containing the nitrocellulose load and the end carrying the fastener (and steel insert, if applicable). This serves an important function in keeping the tool quiet when it is fired because inadequate material thickness in this location, even when an ideal material is used to form the plastic casing, can result in the casing failing to seal the high pressure gasses creating during firing within the tool's nosepiece, resulting in a loud audible report.

The casing will normally be loaded with a given nitrocellulose load of varying power level, color coded, for example, yellow, orange or red, while the open end opposite the load will normally be left empty so that it can receive whichever fastener type is desired. The fasteners are preferably fitted with a tightly attached elastomer sheath which can be located directly beneath the nail head and fitted snugly within the hollow end of the plastic casing to retain the inserted pin inside of the casing. Additionally, the part of the sheath still exposed left sticking out of the casing provides guidance, centering the pin inside a tool's nosepiece whenever the entire assembly is inserted within.

The above-described load-containing plastic casing provides several benefits for both the supplier and the end user.

For the supplier, a reduced number of SKU numbers will be required to keep different power level casings and different models of pins, as opposing to needing a SKU for every combination of pin and casing available. This becomes especially apparent when considering the total number of combinations possible when factoring in the multitude of brackets and clips featuring a dimple and plastic bushings which can receive any compatible fasteners, power loads, or hanger materials such as wires, pencil rods, threaded rods, braided cables, etc.

For the end user, the modular nature of the load-containing plastic casings, pins, and clips allows for on-the-fly adjustment to the fastener size, power levels, brackets and hangers enabling them to obtain optimal results with their unique work site conditions. The design of the load-containing plastic cap clearly communicates which end can receive the fastener, and by extension, clearly shows the correct direction for loading the assembly into the tool, minimizing the chance for user error. The thin walls of the casing surrounding the inserted fastener by securely holding onto the attached elastomer sheath, they also keep the fastener head centered with the bore of the tool and prevent wear between the fastener head and tool bore from occurring.

Lastly, although not directly related to the load-containing plastic casing presented above, the overall modularity of this system allows for third party fasteners and tools, that do not require the nitrocellulose load, to be used to fasten clips containing the dimple and plastic bushing features, for example, piston/blank driven fasteners and tools, making the modular system more attractive and accessible to use.

While certain preferred embodiments of the invention have been described herein, the invention is not to be construed as being so limited, except to the extent that such limitations are found in the claims.

What is claimed is:

1. A bracket for attachment to an overhead substrate to carry a suspending wire or cable forming a loop, said bracket being formed from metal plate or strap stock having a length, a width and a thickness, the length being greater than the width, the width being greater than the thickness, said metal plate or strap stock forming a first section, a second section, and a third section, the third section connected to the second section at a “J”-shaped bend for receiving the loop, the “J”-shaped bend forming a saddle across the width of the metal plate or strap stock having an upwardly-facing convex surface for supporting the loop.

2. A bracket as in claim 1 wherein the metal plate or strap stock further forms a fourth section extending from the third section above the saddle, a gap being left between the first section and the fourth section to permit passage of the loop.

3. A bracket as in claim 2 wherein, when the first section is attached to the overhead substrate, the fourth section is positioned sufficiently close to the overhead substrate to prevent passage of the loop between the overhead substrate and the fourth section of the bracket.

4. A bracket as in claim 2 further comprising a gate element extending across the gap above the saddle swinging downwardly toward the saddle.

5. A bracket as in claim 4 wherein the gate element comprises a spring plate extending from an upper surface of the first section to a lower surface of the fourth section.

6. A bracket as in claim 1 wherein the first section forms at least two stamped ridges protruding downwardly and extending in the length direction to increase stiffness of the first section under load.

7. A bracket as in claim 6 wherein the at least two stamped ridges extend partway around a bend connecting the first section with the second section.

8. A bracket as in claim 2 wherein the width of the third section of metal plate or strap stock is less than the width of the first section, and the fourth section of metal plate or strap stock is greater than the width of the third section of metal plate or strap stock, the fourth section of metal plate or strap stock forming a “T” head on the bracket.

9. A bracket as in claim 8 wherein the third section of metal plate or strap stock forms a neck where it connects to the fourth section of metal plate or strap stock.

10. A bracket as in claim 1 wherein the upwardly-facing convex surface has a radius of curvature in the range of 0.5 to 5 times the width of the first section of metal plate or strap stock.

11. A bracket as in claim 6 wherein the first section of stock has an upper surface and a lower surface and defines a through-aperture and a protuberance on the lower surface that protrudes alongside the second section of stock, said protuberance having a base and an apex, with the through-aperture opening at the apex, and the protuberance forms a bulge having a generally conical outside surface, the upper surface of the first section defining a dimple forming the inside of the bulge.

12. A bracket as in claim 11 further comprising, in combination a nail having a cylindrical shaft, a longitudinal axis, and a pointed distal end, the cylindrical shaft positioned loosely and slidably in the through-aperture of the apex with the pointed distal end protruding in the range of about 0.1 to about 0.5 cm above a surface of the first section of stock opposite to the protuberance.

13. A plastic casing carrying a metal fastener, said plastic casing having
a longitudinal axis and a tubular portion and a cylindrical portion positioned along the longitudinal axis,
the tubular portion extending from the cylindrical portion and forming a cup, each of the tubular portion and the cylindrical portion having an outside diameter, the outside diameters being the same,
the metal fastener having a longitudinal axis, a shaft portion and a head portion positioned along the longitudinal axis,
the longitudinal axis of the metal fastener coinciding with the longitudinal axis of the casing,
the head portion of the metal fastener being positioned in the cup formed by the tubular portion of the casing,
the shaft portion of the metal fastener protruding from the tubular portion of the casing, and
a sabot positioned on the shaft portion of the metal fastener, said sabot having tubular body.

14. A plastic casing carrying a metal fastener as in claim 13 wherein the tubular body of the sabot is formed from an elastomeric substance and closely fits the shaft portion of the fastener.

15. A plastic casing carrying a metal fastener as in claim 14 wherein the sabot has a plurality of ridges extending longitudinally and radially outwardly from the tubular body of the sabot.

16. A plastic casing carrying a metal fastener as in claim 15 wherein the shaft portion of the metal fastener has a first end portion that is threaded and a second end portion that terminates in a tip, wherein the sabot is positioned on the second end portion.

17. A plastic casing carrying a metal fastener as in claim 16 further comprising a metal disk positioned between the head of the metal fastener and the cylindrical portion of the casing.

18. A plastic casing carrying metal fastener as in claim 13 wherein the cylindrical portion has a first end and a second end, said plastic casing carrying a fastener further comprising a cylindrically shaped explosive load encased in a plastic cup positioned in covering relationship with the first end of the cylindrical portion of the plastic casing.

19. A plastic casing carrying a metal fastener as in claim 18 wherein the cylindrical portion of the plastic casing has a first outside diameter extending from the first end of the cylindrical portion of the plastic casing and a second outside diameter extending from the second end of the cylindrical portion, said second diameter being larger than the first, and the plastic cup is positioned snugly over the first outside diameter of the cylindrical portion of the plastic casing, the plastic cup having an outside diameter the same as the second outside diameter of the cylindrical portion of the casing.

20. A plastic casing carrying a metal fastener as in claim 13 wherein the cylindrical portion has a first end and a second end and the first end defines a cup, the cup snugly receiving a cylindrically shaped explosive charge.

21. A plastic casing carrying a metal fastener as in 20 wherein the cylindrically shaped explosive charge is encased in plastic.
